(19) United States
(12) Patent Application Publication
(10) Pub. No.: US 2018/0023963 A1
(43) Pub. Date: Jan. 25, 2018

(54) METHOD FOR CONTROLLING A PERSONAL PROTECTION SYSTEM OF A VEHICLE, AND CONTROL DEVICE

(71) Applicant: Robert Bosch GmbH, Stuttgart (DE)

(72) Inventor: Johannes Ludwig Foltin, Ditzingen (DE)

(21) Appl. No.: 15/647,570

(22) Filed: Jul. 12, 2017

(30) Foreign Application Priority Data
Jul. 19, 2016 (DE) 102016213130.3

(51) Int. Cl. G01C 21/34; G01C 21/30; G08G 1/0968; B60R 25/10

(52) U.S. Cl. CPC G01C 21/3415; B60R 25/1004; G01C 21/30; G08G 1/096827

(57) ABSTRACT

A method for controlling a personal protection system of a vehicle. An item of driving program information, representing a driving program of the vehicle, or, in addition or alternatively, at least one item of additional information, is read in and evaluated to obtain an item of evaluation information. An off-road driving signal, indicating off-road driving of the vehicle, is produced as the evaluation information if the evaluation yields the result that the vehicle is in an off-road driving program or, in addition or alternatively, is driving off a surfaced roadway. If the evaluation yields the result that the vehicle is not in an off-road driving program or, in addition or alternatively, is traveling on a surfaced roadway, then an on-road driving signal, indicating on-road driving of the vehicle, is produced as the evaluation information. Finally, using the evaluation information a control signal is produced for controlling the personal protection system.

### RELATED APPLICATION INFORMATION

The present application claims priority to and the benefit of German patent application no. 10 2016 213 130.3, which was filed in Germany on Jul. 19, 2016, the disclosure which is incorporated herein by reference.

### FIELD OF THE INVENTION

The present invention is based on a device or a method of the for controlling a personal protection system of a vehicle, and control devices. The subject matter of the present invention is also a computer program.

### BACKGROUND INFORMATION

Modern vehicles can be equipped with reversible and non-reversible restraint systems, in order to protect both vehicle occupants and people outside the vehicle from serious injury in the case of a collision. For this purpose, the vehicles can have a plurality of different sensors and actuators.

### SUMMARY OF THE INVENTION

Against this background, with the approach presented here a method is presented for controlling a personal protection system of a vehicle, as well as a control device that uses this method, as well as, finally, a corresponding computer program, according to the main claims. Through the measures indicated in the dependent claims, advantageous developments and improvements of the device indicated in the independent claim are possible.

A method is presented for controlling a personal protection system of a vehicle, the method including the following steps:

reading in an item of driving program information representing a driving program of the vehicle, and/or reading in at least one additional item of information;

evaluating the driving program information and/or the additional information in order to obtain an item of evaluation information, an off-road driving signal, indicating off-road driving of the vehicle, being produced as the item of evaluation information if the evaluation yields the result that the vehicle is in an off-road driving program, and/or is driving off of a surfaced road, and/or a on-road driving signal, indicating on-road driving of the vehicle, being produced as the item of evaluation information if the evaluation yields the result that the vehicle is not in an off-road driving program and/or is traveling on a surfaced road; and

producing a control signal for controlling the personal protection system using the item of evaluation information.

A personal protection system can be understood for example as a system for active, passive, or integrated safety. For example, the personal protection system can include a restraint arrangement such as airbags or safety belts, a pedestrian protection system, or adaptive crash structures. The personal protection system can in addition be fashioned to automatically steer or brake the vehicle when a collision is recognized.

A driving program can be understood as a vehicle setting that can be selected automatically or manually by which a driving behavior of the vehicle can be influenced, for example by modifying transmission switching points, gas pedal characteristic curves, or chassis settings. For example, the driving program can be an off-road program or a sport driving program.

An item of additional information can be understood for example as an item of information read in via an interface to a vehicle-external data processing device, such as an item of GPS information, Car2Car information, or Car2X information. An item of additional information can however also be understood as an item of information provided by at least one sensor of the vehicle, such as an item of information from an environmental or acceleration sensor.

An item of evaluation information can be understood as a result of an evaluation of the driving program information. For example, the evaluation information can indicate whether the vehicle is traveling off-road, or on a surfaced road, i.e. an essentially flat road. The control signal can for example be produced in order to modify at least one threshold value for triggering the personal protection system in accordance with the evaluation information.

Off-road driving can be understood as driving of the vehicle on uneven ground, in particular driving that is not on surfaced roads. Analogously, on-road driving can be understood as driving of the vehicle on a flat surface, in particular a surfaced road. A surfaced road can be understood for example as a paved road or surfaced path.

The approach presented here is based on the recognition that a personal protection system of a vehicle can be controlled as a function of a currently selected driving program setting of the vehicle. For example, by recognizing off-road driving through reading out of the driving program setting, it is possible to reduce the triggering sensitivity of passive safety systems of the vehicle, i.e. to set them to be more robust to vibrations and impacts, and/or to prevent a too-sensitive setting. Here it is advantageous if the read-out driving program setting is additionally calibrated with data from an environmental sensor system of the vehicle.

Through such a control method, restraint and protective arrangement can be prevented from being triggered too early when traveling on an uneven surface, such as when driving off-road or on streets that have potholes.

In particular when traveling off surfaced roads, the vehicle may travel on very uneven surfaces. Here, the vehicle may encounter bushes or branches, or startled animals. Through corresponding controlling of the personal protection system, for example by raising corresponding activation thresholds and/or preventing a lowering of activation thresholds, restraint arrangement can be prevented from being activated in the case of a faulty detection, even if the signals from contact or acceleration sensors of the vehicle are very high. This is advantageous in particular in connection with pedestrian protection systems, in which the activation thresholds can be selected to be comparatively low.

A raising of activation thresholds can also be understood as a prevention of a lowering of activation thresholds. A lowering of activation thresholds can also be understood as a prevention of a raising of activation thresholds.

For example, in the step of reading in, an item of navigation information representing a geographical position of the vehicle, an item of environmental information representing the surrounding environment of the vehicle, or an item of weather information representing a weather condition, can be read in as the additional item of information. An item of navigation information can for example be understood as a position of the vehicle in a virtual map ascertained based on GPS data. Information relating to a roadway segment traveled by the vehicle, in particular relating to the condition of a roadway of the roadway segment, can for example be stored in the virtual map. In particular, the virtual map can be used to recognize whether the vehicle is on a roadway segment or is in an area without (mapped) roadways. An item of environmental information can be understood for example as a signal produced by at least one environmental sensor such as a camera, a radar sensor, or a lidar sensor. The environmental information may have been produced for example in connection with a recognition of a roadway marking or of a traffic sign by the personal protection system. An item of weather information can for example be understood as an item of information concerning a current weather situation in the environment of the vehicle. Through this specific embodiment, the personal protection system can be controlled as a function of the geographical position of the vehicle, objects in the surrounding environment of the vehicle, or the weather conditions.

It is advantageous if, in the step of evaluation, the driving program information and the additional information are weighted, in particular are weighted differently. Weighting can be understood as an evaluation of the driving program information or additional information regarding its respective importance or reliability when ascertaining the evaluation information. For example, here an item of information rated as more important or more reliable can have more influence on a result of the evaluation than an item of information rated as less important or less reliable. In this way, a controlling of the personal protection system is enabled that is as flexible as possible.

According to a further specific embodiment, in the step of reading in at least one further item of additional information can be read in. In the step of plausibilization, the driving program information or, in addition or alternatively, the item of additional information can be plausibilized using the further item of additional information in order to obtain a plausibilized item of driving program information, or a plausibilized item of additional information. Correspondingly, in the step of evaluation the plausibilized driving program information, or the plausibilized additional information, can be evaluated in order to obtain the item of evaluation information.

For example, a further item of additional information can be understood as an item of environmental information from an environmental sensor of the vehicle, such as an item of information representing a lane marking, while the item of additional information can be an item of navigation information. Thus, for example in the step of plausibilization, the item of navigation information can be plausibilized using the item of environmental information. Through this specific embodiment, the robustness of the method can be increased.

In addition, in the step of producing, the control signal can be produced in order to modify at least one threshold value for activating the personal protection system and/or to prevent a modification of the threshold value. In this way, false triggerings of the personal protection system, due for example to vibrations or impacts of the vehicle, can be prevented.

Here, in the step of producing, the control signal can be produced in order to increase the threshold value when the item of evaluation information represents only the off-road driving signal. In addition or alternatively, the control signal can be produced in order to lower the threshold value and/or to permit a lowering when the item of evaluation information represents only the on-road driving signal. The control signal can in addition be produced in order to suppress a lowering of the threshold value when the item of evaluation information represents both the off-road driving signal and also the on-road driving signal. In this way, the personal protection system can be efficiently controlled with the aid of simple signal comparisons requiring low computing expense.

In addition, it is advantageous if, in the step of producing, the control signal is produced in order to increase the threshold value if the item of evaluation information represents driving of the vehicle in a sport driving program. A sport driving program can be understood for example as a vehicle setting having particularly stiff suspension or damping of the vehicle. Through this specific embodiment, false triggerings of the personal protection system can be prevented when the sport driving program is activated.

This method can be implemented for example in software or in hardware, or in a mixed form of software and hardware, for example in a control device.

The approach presented here in addition provides a control device that is fashioned to carry out, control, or realize the steps of a variant of a method presented here in corresponding devices. The underlying object of the present invention can also be realized rapidly and efficiently by this variant embodiment of the present invention in the form of a control device.

For this purpose, the control device can have at least one computing unit for processing signals or data, at least one storage unit for storing signals or data, at least one interface to a sensor or to an actuator for reading in sensor signals from the sensor or for outputting control signals to the actuator, and/or at least one communication interface for reading out or outputting data that are embedded in a communication protocol. The computing unit can be for example a signal processor, a microcontroller, or the like, and the storage unit can be a flash memory, an EPROM, or a magnetic storage unit. The communication interface can be fashioned to read in or output data wirelessly and/or in line-bound fashion, and a communication interface that can read in or output line-bound data can read in these data for example electrically or optically from a corresponding data transmission line or can output them electrically or optically to a corresponding data transmission line.

In the present context, a control device can be understood as an electrical device that processes sensor signals and outputs control and/or data signals as a function thereof. The control device can have an interface that can be fashioned as hardware and/or as software. In the case of a realization as hardware, the interfaces can for example be part of a so-called system ASIC that contains a wide variety of functions of the control device. However, it is also possible for the interfaces to be separate integrated circuits or to be made up at least partly of discrete components. In the case of a realization as software, the interfaces can be software modules present for example on a microcontroller alongside other software modules.

In an advantageous embodiment, the control device carries out a controlling of a personal protection system or an engine control device of the vehicle. For this purpose, the control device can for example access sensor signals such as acceleration, pressure, steering angle, or environmental sensor signals. The controlling takes place via actuators, such as steering or braking actuators, or actuators for controlling reversible restraint arrangement, such as a safety belt or an adjustable engine hood.

Also advantageous is a computer program product or computer program having program code that can be stored on a machine-readable bearer or storage medium such as a semiconductor memory, a hard drive memory, or an optical memory, and can be used to carry out, realize, and/or control the steps of the method according to one of the specific embodiment described above, in particular when the program product or program is executed on a computer or a device.

Exemplary embodiments of the present invention are shown in the drawings and are explained in more detail in the following description.

### BRIEF DESCRIPTION OF THE DRAWINGS

FIG. 1 shows a schematic representation of a vehicle having a control device according to an exemplary embodiment.

FIG. 2 shows a schematic representation of a control device according to an exemplary embodiment.

FIG. 3 shows a flow diagram of a method according to an exemplary embodiment.

FIG. 4 shows a flow diagram of a method according to an exemplary embodiment.

### DETAILED DESCRIPTION

In the following description of advantageous exemplary embodiments of the present invention, identical or similar reference characters are used for the elements shown in the various Figures and having similar function, and repeated description of these elements is omitted.

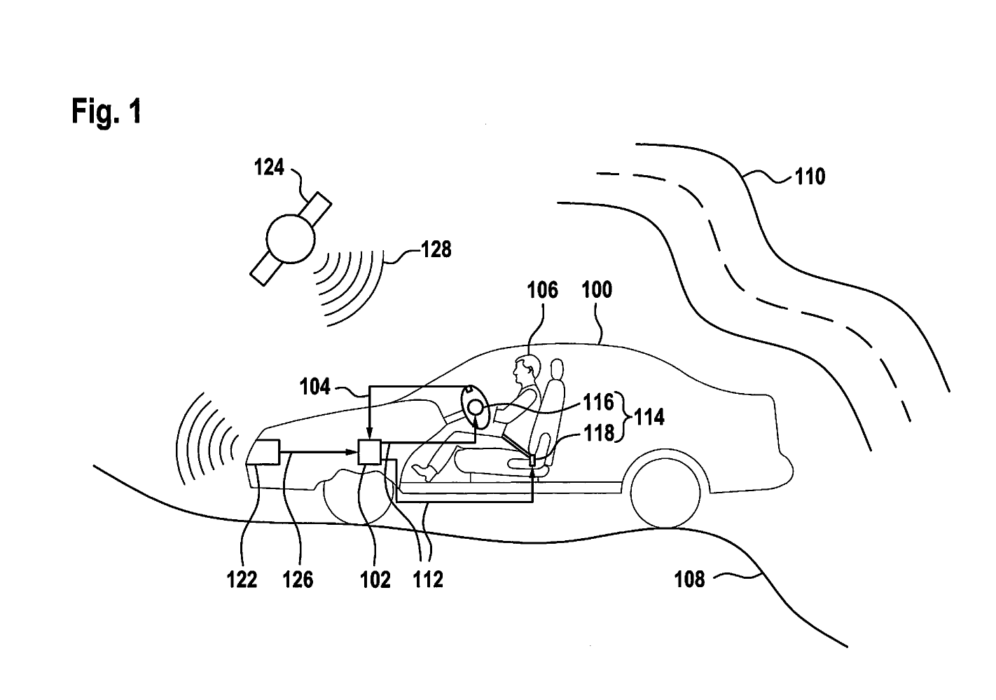

FIG. 1 shows a schematic representation of a vehicle 100 having a control device 102 according to an exemplary embodiment. Control device 102 is fashioned to read in an item of driving program information 104 that represents a driving program of vehicle 100 selected by a driver 106 or selected automatically. Vehicle 100 is situated on an uneven off-road stretch 108, away from a surfaced road 110. Correspondingly, driving program information 104 is an off-road driving program through which the off-road mobility of vehicle 100 is improved when traveling on unsurfaced terrain, for example by selecting a corresponding chassis or drive setting. Control device 102 is fashioned to produce a control signal 112 for controlling a personal protection system 114 of vehicle 100, using driving program information 104. For example, personal protection system 114 shown in FIG. 1 includes passive restraint arrangement in the form of an airbag 116 and a safety belt 118. Using control signal 112, it is for example possible to modify a respective threshold value for the triggering of airbag 116 or of safety belt 118, in particular to increase the threshold value when vehicle 100 is situated on an unsurfaced, uneven surface.

According to an optional exemplary embodiment, control device 102 is fashioned to read in and to process at least one item of additional information in order to produce control signal 112. For this purpose, control device 102, as shown in FIG. 1, is connected on the one hand to an environmental sensor 122 for acquiring a surrounding environment of vehicle 100, and is connected on the other hand via a radio interface to a vehicle-external data processing device 124, here a GPS satellite, in order to read in, from environmental sensor 122, an item of environmental information 126 representing the surrounding environment, and to read in from data processing device 124 an item of navigation information 128 representing a geographical position of vehicle 100. Using these two items of additional information 126, 128 in addition to driving program information 104, control device 102 produces control signal 112. Depending on the exemplary embodiment, control device 102 can here be fashioned to differently weight the two items of additional information 126, 128 and the item of driving program information 104.

In the following, various possible exemplary embodiments of personal protection system 114, and various possibilities for controlling it, are again explained in more detail.

Actuators for passive safety, also called restraint arrangement, include for example active seats, safety belts, or airbags. There are various specific embodiments of airbags, such as driver airbags, knee bags for protecting the knees during forward displacement, or for protection against slipping under the belt, window bags for protecting the head in the case of lateral impact or for protection against objects entering into the passenger compartment from the outside. In the case of an accident, active seats can change their shape in such a way that sliding under the belt is prevented, or the occupant is brought into a more favorable position.

Belt looseness can be reduced by belt tighteners. In this way, the forward displacement of the occupant can be reduced, and the occupant can be decelerated simultaneously with the vehicle.

In order to ascertain an accident or a type of accident, various sensors can be used. The main sensor can be formed by an acceleration sensor, which can be installed in maximally protected fashion in the center of the vehicle.

Pedestrian accidents can be recognized by additional acceleration sensors attached in the front area of the engine hood. In this way, the weak acceleration values caused at the vehicle by a pedestrian can be measured as early as possible.

In addition or alternatively, a pressure hose sensor can be used that can include a silicone hose having for example two pressure sensors at its ends. The pressure hose can be installed behind a bumper. If the bumper is pressed in by the leg of a pedestrian, then the pressure in the hose increases; i.e., a pressure wave is produced in the hose. The sensors recognize the increase in pressure and, from the runtime difference of the pressure wave, can ascertain the position of impact of the pedestrian on the vehicle.

Acceleration sensors can be fashioned at various locations in the vehicle in order to plausibilize the pressure sensor signal.

Pressure sensors in the vehicle doors can be used to recognize a lateral impact, because in the case of a collision the air pressure inside the door briefly increases.

Using a pressure hose on the front of the vehicle, a relatively large surface can be covered using relatively few sensors.

An accident is frequently preceded by strong braking or skidding of the vehicle. In these cases, ABS and ESP systems are active. If the system notices an ABS or ESP intervention, then reversible actuators can be controlled in order to bring the driver or a passenger into a position in which the possibly impending accident can be better withstood. The passenger seat is for example moved into an optimal position, or safety belts are activated or windows are closed. Here, data from the environmental sensor system of the vehicle can be accessed.

After an accident, there are frequently subsequent collisions, because after a first collision the driver often cannot hold the vehicle stable, for example if the driver loses capacity due to the first collision. Corresponding systems, also called secondary collision mitigation systems, can brake the vehicle in a targeted fashion in order to reduce the danger of a further collision, for example with oncoming traffic. In a further design version, the vehicle is kept in its lane while braking in order to completely prevent skidding into oncoming traffic.

Protective functions, such as an airbag triggering algorithm, can in addition be set on the basis of environmental sensor data. Here, environmental sensors, such as mono or stereo cameras, radar, lidar, or ultrasound sensors, acquire the surrounding environment and ascertain an impending collision or collision type. Here, an airbag control device can be set to be more sensitive so that the restraint systems can be triggered more quickly.

For example, a radar sensor can recognize a possible front collision with the vehicle. Up to the predicted collision time, the activation threshold for restraint systems can be reduced.

If the passive safety sensors then register a possible accident, a reaction can take place faster, because the plausibilization duration can be limited. Depending on the design version, a front or side collision can be predicted, or a reaction to a rear collision can also take place. For the collisions, it is possible to distinguish between different accident partners, for example between passenger vehicles, trucks, pedestrians, or a solidly anchored object.

A precondition for such protective systems is that the accident has already taken place. The reaction time is merely shortened, whereby the vehicle occupants can be positioned better for the accident by creating more space for dismantling kinetic energy, thus avoiding acceleration peaks.

Through radar sensors, other objects can be recognized on the basis of echoes of electromagnetic waves previously sent out. The reflection on metallic objects having edges, such as vehicles, is particularly intense, resulting in good detection performance. Metallic objects can result in false detections, if they are for example constructed in the manner of a triple reflector. For example, a cola can, a manhole cover, a guide rail, or a bridge pillar can cause false detections that can trigger an emergency braking assistant.

Camera systems and lidar systems are optical systems that evaluate reflections from active illumination (lidar) or ambient light (camera). Loose particles, or loosely contiguous clouds, can be distinguished from solid objects only with difficulty. Thus, for example vapor from manhole covers, smoke, leaves, or snow may be falsely recognized as objects, which can also trigger an emergency braking assistant. Depending on the situation, a false detection can be avoided through plausibilization or sensor data fusion.

Many so-called SUVs offer a special driving program intended to improve driving comfort when traveling off surfaced roads. Here, for example an ESP system can be adapted in such a way that interventions by the ESP system take place only very late.

Camera systems can recognize roadway markings or signs. Using this information, driver assistance systems such as lane assistance or intelligent cruise control can be controlled.

Using GPS and map information, assistance systems can be adapted as a function of a roadway class. The information about the roadway class can be taken from the navigation information.

The environmental sensor system may for example react wrongly to metallic parts on the roadway. If the vehicle is traveling on a roadway in poor condition and experiences strong vibrations, an individual object wrongly rated as critical, such as a piece of metallic foil blown by the wind, can cause activation of a restraint arrangement.

In order to avoid such false recognitions, it is advantageous if the vehicle is equipped with an off-road recognition unit for evaluating various signals, as is the case for the subject matter of the approach described here.

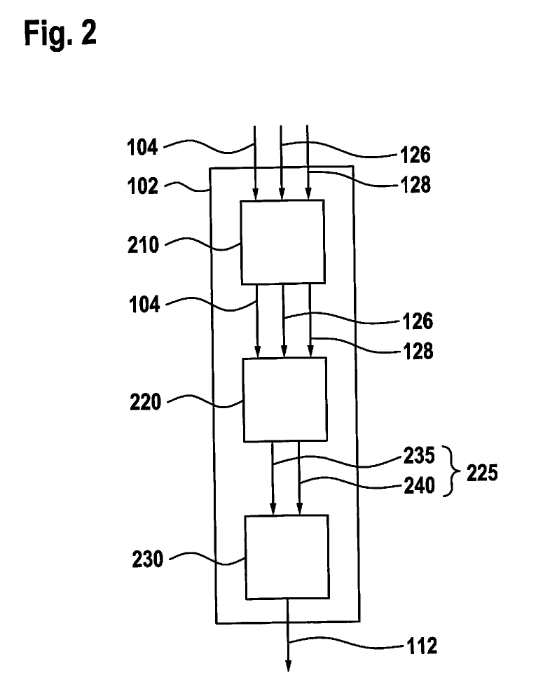

FIG. 2 shows a schematic representation of a control device 102 according to an exemplary embodiment. Control device 102 is for example a control device described above on the basis of FIG. 1. Control device 102 includes a read-in unit 210 for reading in driving program information 104, as well as reading in the two optional items of additional information 126, 128. An evaluation unit 220 connected to read-in unit 210 is fashioned to evaluate the driving program information 104 while additionally using environmental information 126 and navigation information 128. As a result of the evaluation, evaluation unit 220 produces an item of evaluation information 225 that is used by a producing unit 230 of control device 102 to produce control signal 112.

According to an exemplary embodiment, evaluation unit 220 is fashioned to produce an off-road driving signal 235, indicating off-road driving of the vehicle, as evaluation information 225 when the evaluation of driving program information 104 yields the result that the vehicle is traveling in an off-road driving program. In addition, evaluation unit 220 produces off-road driving signal 235 when, in addition or alternatively, at least one of the two items of additional information 126, 128 indicates that the vehicle is moving outside a surfaced roadway, i.e. on unsurfaced terrain.

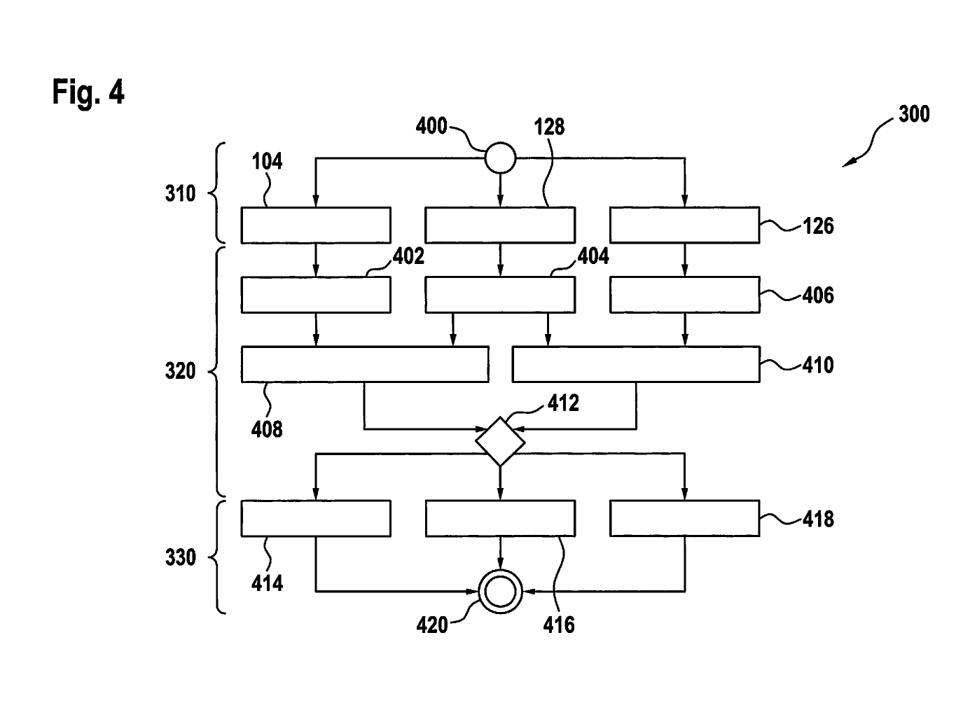

Analogously, evaluation unit 220 produces an on-road driving signal 240, indicating that the vehicle is traveling on a roadway, as item of evaluation information 225 if the evaluation of driving program information 104 yields the result that the vehicle is not driving in an off-road driving program, or, in addition or alternatively, at least one of the two items of additional information 126, 128 indicates that the vehicle is traveling on a surfaced, i.e. essentially flat, roadway. The controlling of the personal protection system using the two signals 235, 240 is described in more detail below on the basis of FIG. 4.

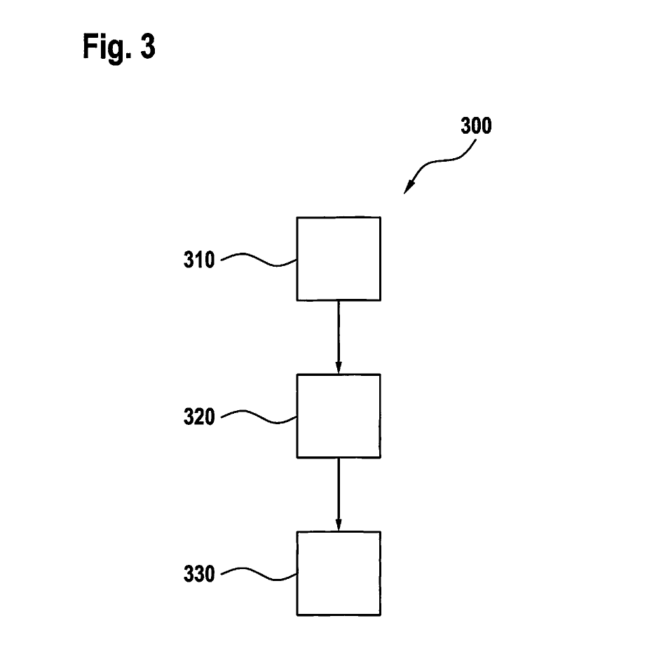

FIG. 3 shows a flow diagram of a method 300 according to an exemplary embodiment. Method 300 can be carried out for example in connection with a control device described above on the basis of FIG. 2. Here, in a step 310 the driving program information is read in. In a further step 320, the driving program information is evaluated in order to obtain the evaluation information. The evaluation information is, finally, used in a step 330 to produce the control signal for controlling the personal protection system of the vehicle.

As already stated, in step 310 in addition at least one optional item of additional information can be read in that can be used in step 320 to evaluate the driving program information.

The steps 310, 320, 330 can be executed continuously.

FIG. 4 shows a flow diagram of a method 300 according to an exemplary embodiment, for example of a method as described above on the basis of FIG. 3. Method 300 starts with a step 400. In response to the starting of method 300, in step 310 driving program information 104, navigation information 128, and environmental information 126, here an item of roadway information, are read in. In step 320, in a first substep 402 driving program information 104 is evaluated, in a second substep 404 navigation information 128 is evaluated, for example with regard to a localization of the vehicle on the basis of a roadway class, and in a third substep 406 environmental information 126 is evaluated.

Depending on the result of the evaluation in the two substeps 402, 404, in a substep 408 of step 320 the off-road driving signal, also called the off-road intermediate signal, is produced. The on-road driving signal, also called the on-road intermediate signal, is produced in a substep 410 of step 320 as a function of a result of the two evaluations in substeps 404, 406.

In a further substep 412 of step 320, the signal states are evaluated after carrying out the two substeps 408, 410.

If it results here that only the off-road driving signal and not the on-road driving signal was produced, then in a substep 414 of step 330 the control signal is produced in order to raise thresholds for triggering the personal protection system and thus to obtain a more robust triggering behavior, or to prevent a lowering of triggering thresholds, and thus to prevent a more sensitive triggering behavior. If, on the other hand, in substep 412 it results that both the off-road driving signal and the on-road driving signal were produced, then in a substep 416 of step 330 the control signal is produced, for example to prevent a threshold lowering, and thus to ensure that a more sensitive triggering is not permitted. In a further substep 418, the control signal is produced in order to enable a lowering of the threshold and thus to permit a more sensitive triggering if the evaluation of the signal states yields the result that neither the off-road driving signal nor the on-road driving signal has been produced.

Method 300 is terminated with a step 420.

In the following, various exemplary embodiments of the present invention are summarized again using other words.

According to an exemplary embodiment, in step 320 it is checked whether the driver has selected an off-road driving program. If this is the case, then certain thresholds for activating the personal protection system are set to be more robust in order to reduce the probability of false triggerings.

According to a further exemplary embodiment, in step 320, on the basis of navigation information it is checked whether the vehicle is traveling on a stored roadway or off such a roadway. If the vehicle is not situated on the stored roadway, the thresholds are set to be more robust.

In addition or alternatively, the thresholds are set to be more sensitive only if the vehicle is situated on a roadway entered in a virtual map.

It is possible for example that the vehicle may be situated in a narrow ravine in which it cannot be located, so that distinguishing between on-road and off-road is not possible on the basis of the navigation information. In this case, for example environmental information can be used to enable a lowering of the thresholds, for example on the basis of a roadway infrastructure that as a rule occurs only on roadways, and correspondingly can act as an indicator.

In the following, a more complex setting logic having intermediate stages is described.

In order to recognize an off-road situation, in step 320 particular vehicle settings are evaluated. If the driver has selected an off-road or rally driving program, the off-road intermediate signal is produced.

The navigation information is for example used to produce the off-road intermediate signal if the vehicle is located off surfaced roadways in the map. If the driving program evaluation or the navigation evaluation yields the result that the vehicle is moving on unsurfaced terrain, the off-road intermediate signal is produced. Depending on the exemplary embodiment, the off-road intermediate signal is produced directly or through a combination of intermediate results.

In order to recognize a roadway situation, for example the navigation information is again evaluated. If the vehicle is located on a roadway, this is an indication that the vehicle is situated in a roadway situation.

By evaluating a roadway infrastructure, which can include roadway markings, signs, street illumination, or traffic lights, through environmental sensor systems or Car2X communication it can be inferred for example that the vehicle is situated on a surfaced roadway.

If the navigation or roadway infrastructure evaluation yields the result that the vehicle is traveling on a surfaced roadway, the on-road intermediate signal is produced. Depending on the exemplary embodiment, the on-road intermediate signal is produced directly or through a combination of intermediate results.

The combination possibilities of off-road and on-road intermediate signals are evaluated.

If only the on-road intermediate signal has been produced, then it can be assumed that the vehicle is situated on a surfaced roadway. Correspondingly, the lowering of the thresholds is enabled, and/or a raising of the thresholds is prevented.

If, on the other hand, only the off-road intermediate signal is produced, then the lowering of the thresholds is not permitted. Rather, in this case the thresholds can be raised in order to enable a still more robust behavior of the personal protection system in the open.

If both signals are produced, then it cannot be unambiguously decided where the vehicle is located. A lowering of the thresholds is then for example prevented.

If no intermediate signal is produced, then a standard value can be used as threshold value. This can be a fixed value or a last-ascertained value.

In addition to an off-road driving program, other driving programs can be used to control the personal protection system. This includes for example an all-wheel drive mode frequently used off-road. If all-wheel drive mode is being used, then in step 320 for example more weight can be given to the item of additional information, in particular the roadway information and localization. In this way, the on-road intermediate signal can be produced more quickly.

In particular, a weather condition signal can also be included in the evaluation in step 320. If for example it has snowed in the surrounding environment of the vehicle, then some drivers will drive using the all-wheel program in order to be able to drive the vehicle better. The evaluation of the environmental information can be adapted using the weather condition information. Thus, in case of doubt when there is snow and the all-wheel mode is activated, a lane can be inferred from vehicles traveling in front or from tracks in the snow, and in this way an on-road intermediate signal can be produced. In all-wheel mode, the on-road intermediate signal can for example be produced even when signal quality is low for localization, given placement on the map next to a roadway, for example in a gully.

The thresholds can also be adapted when a sport driving program is selected. Here, the damping of the chassis is frequently set lower, and for this reason unevenness in the roadway has a stronger effect on the tilting and acceleration behavior of the vehicle.

In the sport driving program, as a rule driving does not take place off road, and for this reason here a different configuration can be selected. Thus, the thresholds can be increased slightly, but less strongly than in the off-road driving program. Here, the production of an off-road intermediate signal is prevented.

If an exemplary embodiment includes an “and/or” linkage between a first feature and a second feature, this is to be read as meaning that according to a first specific embodiment the exemplary embodiment has both the first feature and also the second feature, and according to a further specific embodiment the exemplary embodiment has either only the first feature or only the second feature.

What is claimed is:

1. A method for controlling a personal protection system of a vehicle, the method comprising:
reading in an item of driving program information representing a driving program of the vehicle, and/or at least one item of additional information;
evaluating the item of driving program information and/or the additional item of information to obtain an item of evaluation information, an off-road driving signal, indicating off-road driving of the vehicle, being produced as the item of evaluation information if the evaluation yields the result that the vehicle is in an off-road driving program and/or is traveling off a surfaced roadway, and/or an on-road driving signal, indicating on-road driving of the vehicle, being produced as the item of evaluation information if the evaluation yields the result that the vehicle is not in an off-road driving program and/or is driving on a surfaced roadway; and
producing a control signal for controlling the personal protection system using the item of evaluation information.

2. The method of claim 1, wherein in the reading in, an item of navigation information, representing a geographical position of the vehicle, and/or an item of environmental information, representing a surrounding environment of the vehicle, and/or an item of weather information, representing a weather condition, is read in as the additional item of information.

3. The method of claim 1, wherein in the evaluation, the driving program information and the additional information are weighted, and/or weighted differently.

4. The method of claim 1, wherein in the reading in, at least one further item of additional information is read in, the driving program information and/or the additional information being plausibilized, in a plausibilization, using the further item of additional information, to obtain a plausibilized item of driving program information and/or a plausibilized item of additional information, the plausibilized driving program information and/or the plausibilized additional information being evaluated in the evaluation to obtain the evaluation information.

5. The method of claim 1, wherein in the producing the control signal is produced to modify at least one threshold value for the activation of the personal protection system.

6. The method of claim 5, wherein in the producing the control signal is produced to raise the threshold value and/or to prevent a lowering of the threshold value if the evaluation information represents only the off-road driving signal, and/or to lower the threshold value and/or to prevent a raising of the threshold value if the evaluation information represents only the on-road driving signal, and/or to prevent a lowering of the threshold value if the evaluation information represents both the off-road driving signal and the on-road driving signal.

7. The method of claim 5, wherein in the producing, the control signal is produced to raise the threshold value and/or to prevent a lowering of the threshold value if the evaluation information represents a driving of the vehicle in a sport driving program.

8. A control device for controlling a personal protection system of a vehicle, comprising:
a control arrangement configured for controlling the personal protection system of the vehicle, by performing the following:
reading in an item of driving program information representing a driving program of the vehicle, and/or at least one item of additional information;
evaluating the item of driving program information and/or the additional item of information to obtain an item of evaluation information, an off-road driving signal, indicating off-road driving of the vehicle, being produced as the item of evaluation information if the evaluation yields the result that the vehicle is in an off-road driving program and/or is traveling off a surfaced roadway, and/or an on-road driving signal, indicating on-road driving of the vehicle, being produced as the item of evaluation information if the evaluation yields the result that the vehicle is not in an off-road driving program and/or is driving on a surfaced roadway; and
producing a control signal for controlling the personal protection system using the item of evaluation information.

9. A computer readable medium having a computer program, which is executable by a processor, comprising:
a program code arrangement having program code for controlling a personal protection system of a vehicle, by performing the following:
reading in an item of driving program information representing a driving program of the vehicle, and/or at least one item of additional information;
evaluating the item of driving program information and/or the additional item of information to obtain an item of evaluation information, an off-road driving signal, indicating off-road driving of the vehicle, being produced as the item of evaluation information if the evaluation yields the result that the vehicle is in an off-road driving program and/or is traveling off a surfaced roadway, and/or an on-road driving signal, indicating on-road driving of the vehicle, being produced as the item of evaluation information if the evaluation yields the result that the vehicle is not in an off-road driving program and/or is driving on a surfaced roadway; and
producing a control signal for controlling the personal protection system using the item of evaluation information.

10. The computer readable medium of claim 9, wherein in the reading in, an item of navigation information, representing a geographical position of the vehicle, and/or an item of environmental information, representing a surrounding environment of the vehicle, and/or an item of weather information, representing a weather condition, is read in as the additional item of information.
